(19) United States
(12) Patent Application Publication
(10) Pub. No.: US 2004/0190189 A1
(43) Pub. Date: Sep. 30, 2004

(54) Method for manufacturing MTJ cell of magnetic random access memory

(75) Inventor: Kye Nam Lee, Gyeonggi-do (KR)

Correspondence Address: HELLER EHRMAN WHITE & MCAULIFFE LLP, 1666 K STREET,NW, SUITE 300, WASHINGTON, DC, 20006, US

(73) Assignee: Hynix Semiconductor Inc., Gyeonggi-do (KR)

(21) Appl. No.: 10/734,131

(22) Filed: Dec. 15, 2003

(30) Foreign Application Priority Data
Mar. 26, 2003 (KR) 10-2003-0018920

(51) Int. Cl. G11B 5/596

(52) U.S. Cl. 360/78.04; 360/77.08; 360/78.04

(57) ABSTRACT

The present invention discloses methods for manufacturing MTJ cell of MRAM wherein the surface of a pinned magnetic layer having a crystalline structure of long range order is physically impacted with heavy ions or atom to form an amorphous layer having a crystalline structure of short range order. In accordance with the method, a metal layer for connection layer and a pinned magnetic layer are formed. A surface of the pinned magnetic layer is physically impacted with atom to form an amorphous layer. A tunneling barrier layer, a free magnetic layer and a MTJ capping layer are sequentially formed and the MTJ capping layer, the free magnetic layer, the tunneling barrier layer, amorphous layer and the pinned magnetic layer are patterned using a MTJ cell mask to form a MTJ cell.

### BACKGROUND OF THE INVENTION

1. Field of the Invention

The present invention relates to method for manufacturing MTJ cell of magnetic random access memory (‘MRAM’), and in particular to an improved method for manufacturing MTJ cell of MRAM wherein the surface of a pinned magnetic layer having a crystalline structure of long range order is physically impacted with heavy ions or atom to form an amorphous layer having a crystalline structure of short range order, thereby improving the uniformity of layers deposited in the subsequent processes and overall characteristics of the device.

2. Description of the Background Art

Most of the semiconductor memory manufacturing companies have developed the MRAM, which uses a ferromagnetic material as one of the next generation memory devices.

The MRAM is a memory device for reading and writing information wherein multi-layer ferromagnetic thin films is used by sensing current—variations according to a magnetization direction of the respective thin films. The MRAM has a high speed and low power consumption, and allows high integration density due to its unique properties of the magnetic thin film, and also performs a nonvolatile memory operation such as a flash memory.

The MRAM embodies a memory device by using a giant magneto resistive (GMR) or spin-polarized magneto-transmission (SPMT) phenomenon generated when the spin influences electron transmission.

The MRAM using the GMR phenomenon utilizes the fact that resistance remarkably varies when spin directions are different in two magnetic layers having a non-magnetic layer therebetween to implement a GMR magnetic memory device.

The MRAM using the SPMT phenomenon utilizes the fact that larger current transmission is generated when spin directions are identical in two magnetic layers having an insulating layer therebetween to implement a magnetic permeable junction memory device.

A MRAM includes a transistor and a MTJ cell (Magnetic Tunnel Junction cell).

FIG. 1 illustrates a cross-sectional view of a MTJ cell implemented by a conventional manufacturing method thereof.

Referring to FIG. 1, a device isolation film (not shown), a first word line (not shown) which serves as a read line, a transistor (not shown) having a source/drain region, a ground line (not shown), a conductive layer (not shown) and a second word line (not shown) which serves as a write line are formed on a semiconductor substrate (not shown). A lower insulating layer 11 planarizing the entire surface is then formed on the semiconductor substrate. The conductive layer contacts the semiconductor substrate through the lower insulating layer 11 and the lower insulating layer 11 exposes the top surface of the conductive layer.

Thereafter, a metal layer 13 for connection layer connected to the conductive layer is formed on the lower insulating layer 11. The metal layer 13 comprises a metal selected from the group consisting of tungsten, aluminum, platinum, copper, iridium, ruthenium and combinations thereof.

Next, a pinned magnetic layer 15 is formed on the metal layer 13. The pinned magnetic layer 15 comprises a magnetic material selected from the group consisting of Co, Fe, NiFe, CoFe, PtMn, IrMn and combinations thereof. The pinned magnetic layer 15 has a crystalline structure having specific grain boundary, i.e. a crystalline structure of long-range order. The crystalline structure of long-range order degrades the uniformity of the layers deposited on the pinned magnetic layer 15.

Next, a tunneling barrier layer 17 is formed on the pinned magnetic layer 15. The tunneling barrier layer 15 consists of an insulating layer. The uniformity of the thickness of the tunneling barrier layer 17 is drastically degraded at the triple point where the grain boundary of the pinned magnetic layer 15 and the tunneling barrier layer 17 interface one another. In particular, when the tunneling barrier layer 17 is grown in the form of a column, the uniformity of the tunneling barrier layer 17 is by far degraded shown as “A” in FIG. 1.

Thereafter, a free magnetic layer 19 is deposited on the tunneling barrier layer 17. The free magnetic layer 19 comprises a magnetic material selected from the group consisting of Co, Fe, NiFe, CoFe, PtMn, IrMn and combinations thereof.

A MTJ capping layer 21 is then formed on the free magnetic layer 19.

The MTJ capping layer 21, the free magnetic layer 19, the tunneling barrier layer 17 and the pinned magnetic layer 15 are patterned via photolithography process using a MTJ cell mask (not shown) to form a MTJ cell.

As described above, in accordance with the method for manufacturing MTJ cell of MRAM, poor uniformity of the pinned magnetic layer degrades the uniformity of the tunneling barrier layer and the free magnetic layer formed thereon to deteriorate the characteristics of the MTJ cell and overall reliability of the device.

### SUMMARY OF THE INVENTION

Accordingly, it is an object of the present invention to provide method for manufacturing MTJ cell of MRAM wherein the surface of the pinned magnetic layer having a crystalline structure of long range order is impacted with atom having a large atomic weight to form an amorphous layer having a crystalline structure of short range order on the pinned magnetic layer to improve uniformity of layers and overall characteristics of the MTJ cell.

In order to achieve the above-described object of the invention, there is provided a method for manufacturing MTJ cell of MRAM comprising: forming a metal layer for connection layer connected to a semiconductor substrate through a lower insulating layer; forming a pinned magnetic layer on the metal layer; physically impacting a surface of the pinned magnetic layer with an atom to form an amorphous layer thereon; sequentially forming a tunneling barrier layer, a free magnetic layer and a MTJ capping layer on the amorphous layer; and patterning the MTJ capping layer, the free magnetic layer, the tunneling barrier layer, amorphous layer and the pinned magnetic layer using a MTJ cell mask to form a MTJ cell.

### BRIEF DESCRIPTION OF THE DRAWINGS

The present invention will become better understood with reference to the accompanying drawings which are given only by way of illustration and thus are not limitative of the present invention, wherein:

FIG. 1 illustrates a cross-sectional view of a MTJ cell implemented by a conventional method.

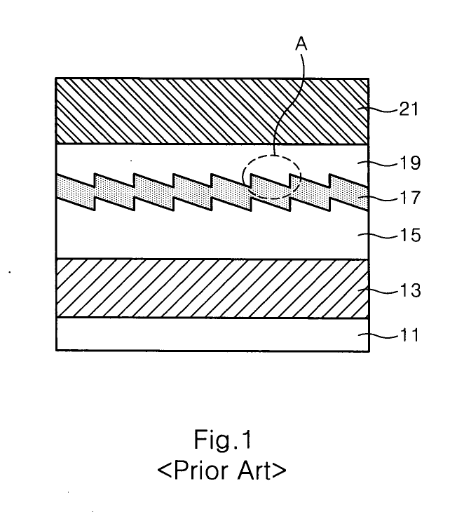

FIG. 2 illustrates a cross-sectional view of a MTJ cell of MRAM manufactured by the method in accordance with the present invention.

### DETAILED DESCRIPTION OF THE PREFERRED EMBODIMENTS

A method for manufacturing a MTJ cell of a MRAM in accordance with a preferred embodiment of the present invention will now be described in detail with reference to the accompanying drawings.

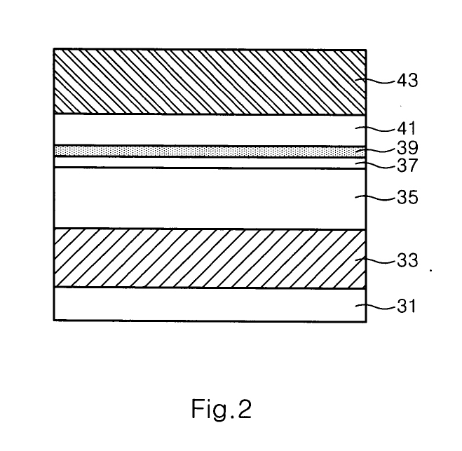

FIG. 2 illustrates a cross-sectional view of a MTJ cell of MRAM manufactured by the method in accordance with the present invention.

Referring to FIG. 2, a device isolation film (not shown), a first word line (not shown) which serves as a read line, a transistor (not shown) having a source/drain region, a ground line (not shown), a conductive layer (not shown) and a second word line (not shown) which serves as a write line are formed on a semiconductor substrate (not shown). A lower insulating layer 31 planarizing the entire surface is then formed on the semiconductor substrate. The conductive layer contacts the semiconductor substrate through the lower insulating layer 31 and the lower insulating layer 31 exposes the top surface of the conductive layer.

Thereafter, a metal layer 33 for connection layer connected to the conductive layer is formed on the lower insulating layer 31. Preferably, the metal layer 33 comprises a metal selected from the group consisting of tungsten, aluminum, platinum, copper, iridium, ruthenium and combinations thereof.

Next, a pinned magnetic layer 35 is formed on the metal layer 33. Preferably, the pinned magnetic layer 35 comprises a magnetic material selected from the group consisting of Co, Fe, NiFe, CoFe, PtMn, IrMn and combinations thereof. The pinned magnetic layer 35 has a crystalline structure having a grain boundary, i.e. a crystalline structure of long-range order.

Thereafter, a surface of the pinned magnetic layer 35 is impacted with atom having an atomic weight larger than boron, for example P or As. The physical impact improves the uniformity of the surface, thereby forming an amorphous layer 37 thereon.

Next, a tunneling barrier layer 39 and a free magnetic layer 41 is sequentially formed on the amorphous layer 37. The free magnetic layer 41 comprises a magnetic material selected from the group consisting of Co, Fe, NiFe, CoFe, PtMn, IrMn and combinations thereof.

A MTJ capping layer 43 is then formed on the free magnetic layer 41. The MTJ capping layer 43, the free magnetic layer 41, the tunneling barrier layer 39, the amorphous layer 37 and the pinned magnetic layer 35 are then patterned via photolithography process using a MTJ cell mask (not shown) to form a MTJ cell.

The present invention can be applied not only to the method for manufacturing MTJ cell but also to the methods for manufacturing a device utilizing electrical resistance of magnetic material, magnetic device employing current perpendicular plain method by stacking magnetic material, and patterning of magnetic film structure for obtaining electrical characteristic differences.

As discussed earlier, in accordance with the present invention, the method for manufacturing MTJ cell of MRAM provides uniform layers and improved the characteristics of the MTJ cell by forming the amorphous layer having a crystalline structure of short range order on the pinned magnetic layer via impacting the surface of the pinned magnetic layer having a crystalline structure of long range order with atom having a large atomic weight.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. A method for manufacturing MTJ cell of MRAM comprising:
forming a metal layer for connection layer connected to a semiconductor substrate through a lower insulating layer;
forming a pinned magnetic layer on the metal layer;
physically impacting a surface of the pinned magnetic layer with an atom to form an amorphous layer thereon;
sequentially forming a tunneling barrier layer, a free magnetic layer and a MTJ capping layer on the amorphous layer; and
patterning the MTJ capping layer, the free magnetic layer, the tunneling barrier layer, amorphous layer and the pinned magnetic layer using a MTJ cell mask to form a MTJ cell.

2. The method according to claim 1, wherein the atom is selected form the group consisting of P or As.
